(19) United States
(12) Patent Application Publication
(10) Pub. No.: US 2005/0236060 A1
(43) Pub. Date: Oct. 27, 2005

(54) Multilayer plated fuel line parts for automobile

(76) Inventor: Norifumi Matsubara, Ibaraki-Ken (JP)

Correspondence Address: LADAS & PARRY, 26 WEST 61ST STREET, NEW YORK, NY, 10023, US

(21) Appl. No.: 10/519,602

(22) PCT Filed: Jul. 18, 2003
(86) PCT No.: PCT/JP03/09203

§ 371 Date: Dec. 29, 2004

(30) Foreign Application Priority Data
Jul. 24, 2002 (JP) 2002-215209

(51) Int. Cl. F16L 9/14

(52) U.S. Cl. 138/143; 138/146

(57) ABSTRACT

A trivalent chromate coating having improved surface smoothness is used as an alternative to a hexavalent chromate coating serving as a protective coating. A piping member of a steel for an automotive fuel line is coated with a multilayer coating consisting of a plated Zn—Ni alloy film as a bottom layer, a plated Zn film as an intermediate layer overlying the plated Zn—Ni alloy layer, and a trivalent chromate layer as a top layer overlying the plated Zn film.

### TECHNICAL FIELD

The present invention relates to a piping member for an automotive fuel line, such as a fuel delivery pipe, coated with a multilayer coating including a chromate coating.

### BACKGROUND ART

The surface of a member, such as a metal tube, of an automotive fuel line is coated with a plated film to improve the necessary mechanical properties of the member that cannot be provided by a material forming the member, such as corrosion resistance and chemical resistance to meet the requirements of use.

For example, a fuel delivery pipe for distributing fuel supplied through a fuel supply pipe to injectors is prevented from corrosion, in most cases, by plating the fuel supply pipe with a Zn—Ni alloy. It has been a widespread coating method to plate the surface of a steel sheet with a Zn—Ni alloy film by plating, and to coat the Zn—Ni alloy film with a chromate coating containing hexavalent chromate (hereinafter, referred to as “hexavalent chromate coating”) as a protective layer. The Zn—Ni film is coated with the chromate coating to prevent corrosion because white rust is liable to be formed on the Zn—Ni ally film due to the oxidation of Zn.

The chromate coating contains hexavalent chromium, which is detrimental to the environment. Therefore, it is the trend of the time to use a chromate coating containing trivalent chromium (hereinafter, referred to as “trivalent chromate coating”) as an alternative to the hexavalent chromate coating in view of environmental protection.

Techniques of this kinds are disclosed in, for example, JP-A 2001-181856 and JP-A 2000-252042.

A plated film formed on the fuel delivery pipe must be corrosion-resistant, while a plated film formed on an injector cup must be corrosion-resistant as a matter of course and must have a smooth surface.

An O ring is put on a joining part of an injector to be fitted in an injector cup to prevent the leakage of gasoline. Little gap is formed between the joining part of the injector and the injector cup. The joining part of the injector is pressed in the injector cup, and the injector is fixed to the injector cup with a stopper or the like.

The joining part of the injector should not be lubricated with a lubricant with an intention to facilitate fitting the joining part in the injector cup to avoid failing in finding the leakage of gasoline.

When the surface of an injector cup is coated with a hexavalent chromate coating as a protective layer, high frictional resistance acts on the injector when the injector is fitted in the injector cup and, in some case, the O ring put on the injector is damaged or broken because the hexavalent chromate coat has a rough surface.

The adhesion of the trivalent chromate coating as an alternative to the hexavalent chromate coat to the plated Zn—Ni alloy film is low and the trivalent chromate coating is damaged when the injector is fitted in the injector cup. Thus the trivalent chromate coating is unsuitable for coating a fuel delivery pipe.

### DISCLOSURE OF THE INVENTION

Accordingly, it is an object of the present invention to solve the foregoing problems in the prior art techniques and to provide a piping member with a multilayer coating for an automotive fuel line, including a trivalent chromate coating having a smooth surface as a protective layer

Another object of the present invention is to provide a fuel delivery pipe coated with a protective film having a highly smooth surface, capable of preventing damaging a sealing member, such as an O ring, and facilitating press fitting work.

A piping member with a multilayer coating for an automotive fuel supply line is formed by processing a steel sheet coated with a multilayer coating consisting of a plated Zn—Ni alloy film as a bottom layer, a plated Zink film as an intermediate layer, and a trivalent chromate coating as a top layer.

Generally, the surface of the trivalent chromate coating is less rough than that of the hexavalent chromate coating. However, the adhesion of the trivalent chromate coating to the plated Zn—Ni alloy film is low and the surface of the trivalent chromate coating is not satisfactorily smooth if the trivalent chromate coating is formed directly on the plated Zn—Ni alloy film. The plated Zn film as an intermediate layer underlying the trivalent chromate coating can improve the smoothness of the surface of the trivalent chromate coating greatly.

Preferably, the piping member of the present invention for an automotive fuel supply line is a fuel delivery pipe having the trivalent chromate coating having high smoothness, facilitating fitting an injector in an injector cup and capable of preventing damaging an O ring.

### BRIEF DESCRIPTION OF THE DRAWINGS

FIG. 1 is a side elevation of a fuel delivery pipe with a multilayer coating, namely, a piping member for an automotive fuel line, in a preferred embodiment according to the present invention;

FIG. 2 is a cross sectional view of the fuel delivery pipe shown in FIG. 1;

FIG. 3 is a typical sectional view of a multilayer coating coating the surface of a base member;

FIG. 4 is a typical sectional view of another multilayer coating coating the surface of a base member;

FIG. 5 is a micrograph of the surface of a trivalent chromate coating included in the preferred embodiment of the present invention;

FIG. 6 is a micrograph of the surface of a trivalent chromate coating as Comparative example 1 formed over a plated Zn—Ni alloy film;

FIG. 7 is a micrograph of the surface of a hexavalent chromate coating in Comparative example 2 formed over a plated Zn—Ni alloy film; and

FIG. 8 is a micrograph of the surface of a hexavalent chromate coating in Comparative example 3 formed over a plated Zn film.

### BEST MODE FOR CARRYING OUT THE INVENTION

A preferred embodiment of the present invention will be described with reference to the accompanying drawings.

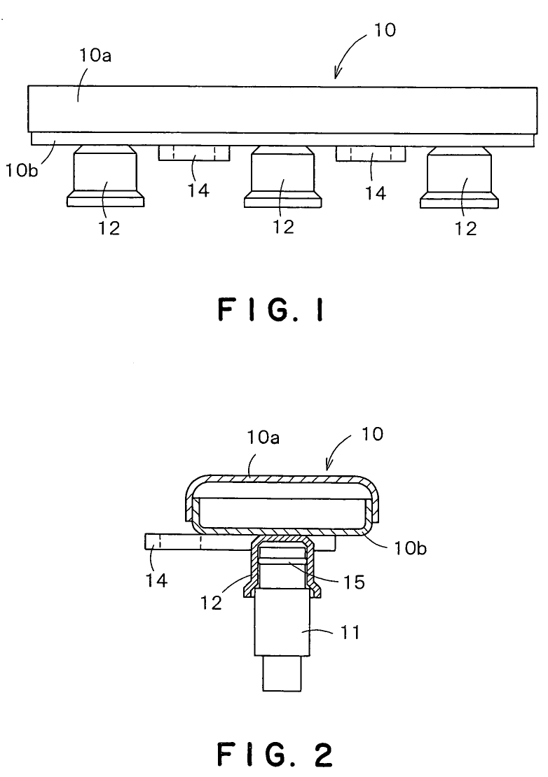

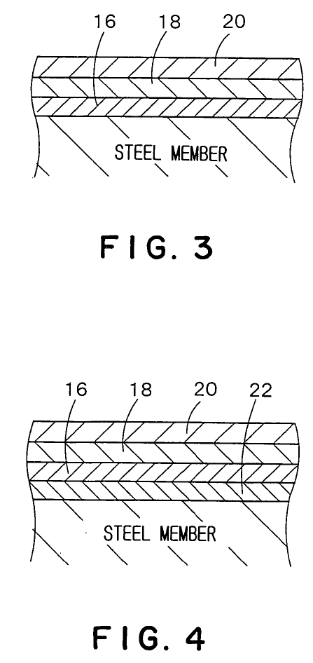

FIG. 1 is a side elevation of a fuel delivery pipe in a referred embodiment according to the present invention to be coated with a multilayer coating and FIG. 2 is a sectional view of the fuel delivery pipe.

The fuel delivery pipe has a body 10 having an upper case 10a and a lower case 10b. The upper case 10a and the lower case 10b are fabricating by subjecting a steel sheet to press working. The upper case 10a and the lower case 10b are combined, and the joint of the upper case 10a and the lower case 10b is brazed to join the upper case 10a and the lower case 10b together. Cups 12 for holding injectors 11 are attached to the lower wall of the lower case 10b. Indicated at 14 are brackets.

The surface of the fuel delivery pipe is coated with a three-layer film consisting of a bottom, plated Zn—Ni alloy film 16, an intermediate, plated Zn film 18 and a top trivalent chromate coating 20. The outer surfaces of the upper case 10a and the lower case 10b of the body 10 of the fuel delivery pipe are coated with the three-layer film. The outer and inner surfaces of the cups 12 are coated with the three-layer film.

The plated Zn—Ni alloy film 16, the plated Zn film 18 and the trivalent chromate coating 20 will be described.

Plated Zn—Ni Alloy Film

The plated Zn—Ni alloy film 16 is formed by an electroplating process that immerses the fuel delivery pipe 10 provided with the cups 12 in an alkali plating bath not containing cyan. The thickness of the plated Zn—Ni alloy film 16 is between about 5 and about 10 μm. The Ni content of the plated Zn—Ni alloy film 16 is about 5 and about 15% by weight, preferably, between 6 to 10% by weight.

Plated Zn Film

The plated Zn film 18 is formed by an electroplating process that immerses the fuel delivery pipe 10 coated with the plated Zn—Ni alloy film 16 in a Zn-plating bath. The thickness of the plated Zn film is between about 5 and about 10 μm.

Trivalent Chromate Coating

The surface of the fuel delivery pipe 10 coated with the plated Zn—Ni alloy film 16 and the plated Zn film 18 is wetted with a chromating solution, and then a film of the chromating solution is dried to form the trivalent chromate coating 20 over the plated Zn film 18. The chromating solution is a processing solution prepared for a trivalent chromating process. The trivalent chromate coating 20 has a basis weight in the range of 0.4 to 0.8 mg/dm² and a thickness in the range of 0.1 to 1.0 μm.

A joining part provided with an O ring 15 of an injector 14 was pressed in the cup 12 of the fuel delivery pipe 10 coated with the three-layer film consisting of the plated Zn—Ni alloy film 16, the plated Zn film 18 and the trivalent chromate coating 20 as shown in FIG. 2. Resistance against the insertion of the injector 14 in the cup 12 was lower than that against the insertion of the injector 14 in a conventional cup coated with a coating film having a top hexavalent chromate coating and the injector 14 could smoothly fitted in the cup 12.

The effect of the trivalent chromate coating 20 on reducing resistance against the insertion of the injector in the cup will be explained.

FIG. 5 is a micrograph at a magnification of 3000× of the surface of the trivalent chromate coating formed over the plated Zn film and included in the preferred embodiment of the present invention.

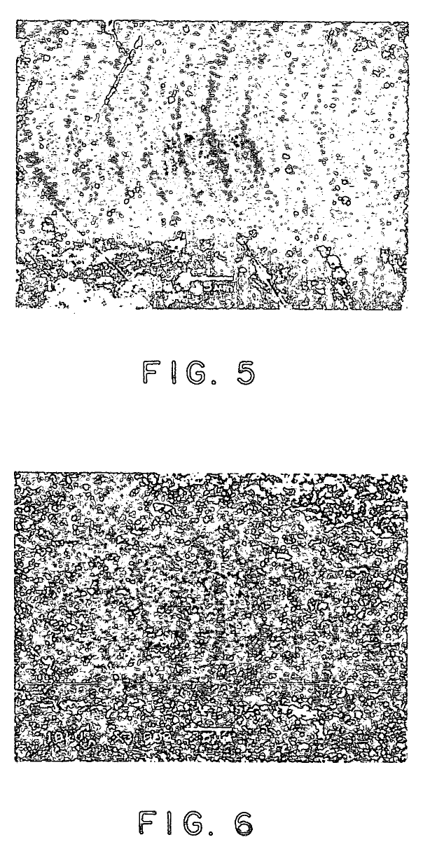

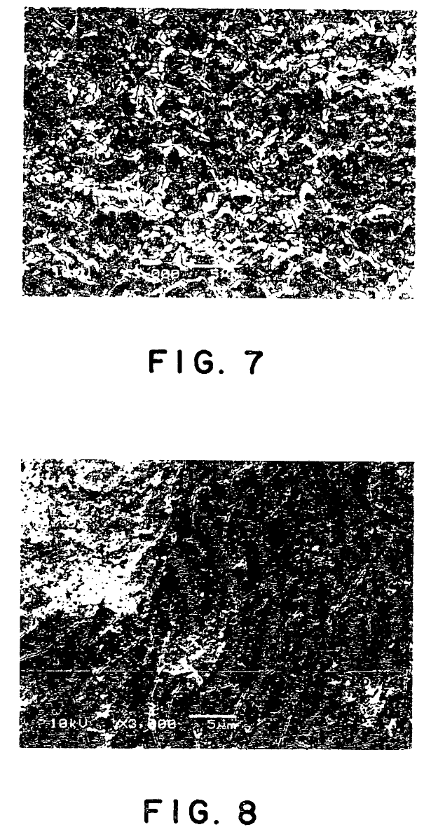

FIG. 6 is a micrograph at a 3000× magnification of the surface of a trivalent chromate coating as Comparative example 1 formed over a plated Zn—Ni alloy film, and FIG. 7 is a micrograph at a 3000× magnification of the surface of a hexavalent chromate coating in Comparative example 2 formed over a plated Zn—Ni alloy film.

It is known from the comparative observation of the trivalent chromate coating in Comparative example 1 and the hexavalent chromate coating in Comparative example 2 that the irregularities of the surface of the trivalent chromate coating formed over the plated Zn—Ni alloy film is finer than that of the surface of the hexavalent chromate coating formed over the plated Zn—Ni alloy film.

As obvious from FIG. 5, the surface of the trivalent chromate coating overlying a plated Zn film is very smooth

It is obvious from the comparative observation of the surface of a hexavalent chromate coating in Comparative example 3 formed over a plated Zn—Ni alloy film similarly to the trivalent chromate coating of the embodiment and the surface of the trivalent chromate coating of the embodiment that the respective surfaces of the trivalent chromate coating and the hexavalent coating differ greatly from each other in smoothness, and the surface of the trivalent chromate coating is far smoother than that of the hexavalent chromate coating.

Thus it is known that the trivalent chromate coating has high adhesion to the plated Zn film and the formation of the trivalent chromate coating over the plated Zn film instead of on the plated Zn—Ni film improves the smoothness of the surface of the trivalent chromate coating very effectively.

The injector 11 can be smoothly pressed in the cup 12 of the fuel delivery pipe 10 in this embodiment of the present invention because the surface of the trivalent chromate layer is very smooth.

From the point of view of corrosion prevention, the highly corrosion-resistant plated Zn—Ni alloy film coating the steel sheet forming the body is more effective than the plated Zn film. White rust will not be formed in the intermediate, plated Zn film because the plated Zn film is isolated from air by the trivalent chromate coating. The use of the plated Zn—Ni alloy film and the plated Zn film in combination improves corrosion resistance.

FIG. 4 shows a multilayer coating formed on the surface of a base for a fuel delivery pipe in a second embodiment according to the present invention and consisting of a plated Ni film 22, a plated Zn—Ni alloy film 16, a plated Zn film 18 and a trivalent chromate coating formed in that order on the surface of the base.

Preferably, the plated Ni film 22 is formed in a thickness of 3 μm or above by an electroplating process that immerses a fuel delivery pipe 10 in a Ni-plating bath

The plated Ni film 22 as the bottom layer improves the corrosion resistance of the fuel delivery pipe.

Although the fuel delivery pipe coated with the multilayer coating as an example of the piping member for an automotive fuel line according to the present invention, the present invention is applicable to other piping members of an automotive fuel line, such as tubes each having an end part to be pressed in another member.

As apparent from the foregoing description, according to the present invention, the adhesion of the trivalent chromate coating as an alternative to a hexavalent chromate coating to a plated film can be increase, and the smoothness of the surface of the trivalent chromate coating can be improved.

When the fuel delivery pipe, namely, a piping member, is coated with the multilayer coating according to the present invention the injector, namely, a member to be combined with the piping member, can be combined with the fuel delivery pipe by press fitting without damaging a sealing member, such as an O ring.

1. A piping member for an automotive fuel line, coated with a multilayer coating including a chromate coating as a top layer;
characterized in that multilayer coating comprises a plated Zn—Ni alloy film as a bottom layer, a plated Zn film as an intermediate layer overlying the plated Zn—Ni alloy layer, and a trivalent chromate layer as a top layer overlying the plated Zn film.

2. The piping member for an automotive fuel line according to claim 1 characterized in that the multilayer coating further comprises a plated Ni film underlying the plated Zn—Ni alloy film.

3. The piping member for an automotive fuel line according to claim 1 is a fuel delivery pipe provided with cups in which injectors are inserted by press fitting.

4. The piping member for an automotive fuel line according to claim 1, wherein the plated Zn—Ni alloy film ha a thickness between t and 10 μm, the plated Zn film has a thickness between 5 and 10 Mm, and the trivalent chromate coating has a thickness between 0.1 and 1.0 μm.
